(19) United States
(12) Patent Application Publication
(10) Pub. No.: US 2012/0185233 A1
(43) Pub. Date: Jul. 19, 2012

(54) Method and System for Analyzing Temporal Flow Characteristics

(75) Inventors: Andreas ALBRECHT, Pirk (DE); Hermann Sehr, Kastl (DE)

(73) Assignee: Siemens Aktiengesellschaft, Muenchen (DE)

(21) Appl. No.: 13/348,049

(22) Filed: Jan. 11, 2012

(30) Foreign Application Priority Data
Jan. 13, 2011 (EP) EP11150836

(51) Int. Cl. G06F 9/45

(52) U.S. Cl. 703/22

(57) ABSTRACT

A method and a system for analyzing temporal flow characteristics by which processing times for module labels of program modules can be graphically represented in a display to provide a user of an industrial controller with an enhanced way to analyze a distribution of the computing times of each individual program module.

### BACKGROUND OF THE INVENTION

1. Field of the Invention

The invention relates to data analysis and, more particularly, to a method for analyzing temporal flow characteristics of a control program of an industrial controller, where the control program is divided into a main module and a plurality of program modules, the main module being processed cyclically following initialization and the processing of the program modules being event-driven, and where the program modules are assigned a processing priority.

The invention further relates to a system for analyzing temporal flow characteristics of a control program of an industrial controller, comprising the industrial controller and an analysis unit which is connected to the industrial controller via a communication connection.

In accordance with the invention, an industrial controller is preferably understood to mean a stored programmable control (SPC), which is an automation device used to control or regulate a machine or equipment in an industrial environment. If an SPC works based on a cycle, this cycle is monitored by an operating system that has been permanently installed by the manufacturer. Depending on its program modules, the control program can contain branch points and conditional calls, and this can result in different durations.

2. Description of the Related Art

Currently, a user of an industrial controller is provided with no way to analyze a distribution of computing times over individual program modules, because the program modules are executed according to different priorities in the industrial controller and can themselves be interrupted by program modules of higher priority. Consequently, a user can only approximately identify the amount of computing time that is available on a CPU of the industrial controller, or the extent to which this CPU is loaded.

### SUMMARY OF THE INVENTION

It is therefore an object of the present invention to provide method that permits a user to optimize temporal flow characteristics of a control program to increase the efficiency of an industrial controller in the context of automation engineering.

This and other objects and advantages are achieved in accordance with the invention by a method in which a processing time is calculated for each of the program modules, where the processing time is derived from the difference between the time point at the end of processing and the time point at the start of processing of the respective program module, whereupon in a further step the respective processing time is assigned to a module label of the respective program module and this assignment is graphically represented in a display. It was previously only possible to specify a current cycle time for the main module, e.g., an OB1 module for the cyclical processing. This only allowed a limited scope for inferring the load distribution in the industrial controller. By virtue of the representation in a graphical display, e.g., on an analysis unit, preferably an engineering system, and more preferably a programming device that is connected to the industrial controller, the user can now obtain a clear impression of the load distribution of the individual program modules in the industrial controller. Using optimization measures, the user can now influence the temporal flow characteristics of the control program.

In an advantageous embodiment of the method, in addition to the module label and the processing time, the processing priority of the program module is represented in the display such that the processing priority can be modified interactively and the changed processing priority can be assigned to the relevant program module and taken into consideration in the control program. Having gained an understanding of the individual characteristics of the individual program modules by the graphical representation, the user can reprogram a corresponding processing priority for the corresponding program module by interactively operation performed in the display (e.g., by input/output windows) and return the processing priority to the controller such that the consequences of the changes are immediately visible to the user and can be further optimized if necessary by the interactive operation. Preferably, the user can influence the interruptions of the individual program modules using the calculated time measurement data and by changing the priorities.

An optimization can also be effected by calculating an execution period in addition to the processing time for each program module, where the execution period is calculated from the sum of the time periods in which the program module actively services its program instructions. The execution period can also be seen as a net duration of a program module. The net duration is therefore the time, excluding interruptions, a program module would require to execute completely, i.e., only those time segments in which the program module is actively working. The processing time could then be referred to as a gross duration, i.e., the time that a program module requires from a starting time point to an ending time point, including interruptions. Using a graphical representation of the processing time and the execution time (i.e., net duration and gross duration, respectively), the decision concerning user intervention for the purpose of optimization is made easier. A large discrepancy between gross duration and net duration indicates a frequent or lengthy interruption of the program flow.

Provision is advantageously made for calculating a discrepancy between the processing time and the execution period, where a warning is generated in the display if the discrepancy exceeds a configurable value.

Moreover, provision is advantageously made for calculating a communication time comprising time periods in which the control program is occupied with communication tasks for communication with automation components that are attached to the industrial controller, and time periods for the communication time likewise to be represented in the display. Representation of the communication time in conjunction with the times of the program modules allows the communication load in the industrial controller to be analyzed, where a graphical representation of the communication load is advantageous here since the communication load nonetheless demands a relatively large amount of computing time.

In a further embodiment of the method, further duration-relevant parameters can be modified interactively for a program module, thereby optimizing the temporal flow characteristics of the control program, where the changed parameters concerned are immediately taken into consideration in the control program. The representation and preparation of the calculated or measured time values are represented as an animated flow layer model in the display, e.g., in a Windows user interface. The changes to the parameters can also be effected in this display.

For the purpose of further representations, a minimal, maximal, current and cumulative processing time and/or execution period are also calculated and represented in the display.

The object is further achieved by a system for analyzing temporal flow characteristics of a control program. A recording device, which is arranged in the industrial controller, is configured so as to calculate a processing time for each program module, where the processing time is derived from the difference between the time point at the end of processing and the time point at the start of processing of the program module concerned, and to forward the processing time and a module label of the respective program module to an analysis unit via the communication connection, and where the analysis unit is moreover configured so as to graphically represent the assignments of the processing time to the module label in a display. The system in accordance with the invention allows a user of the industrial controller to analyze the distribution of the computing times over the individual program modules.

In a further embodiment of the disclosed system, the analysis unit is configured so as to represent the processing priority of the program module in addition to the module label and the processing time in the display, such that the processing priority can be modified interactively, and to send the changed processing priority to the relevant program module via the communication connection such that this processing priority can be taken into consideration in the control program. As a result, the user is allowed to undertake optimizations in relation to the flow characteristics, and to immediately check the effectiveness of the optimization measures.

In a further embodiment, the recording device is configured so as to calculate an execution period of each program module, where the execution period is calculated from the sum of the time periods in which the program module actively services its program instructions, and to forward the calculated execution period to the analysis unit via the communication connection.

Here, the analysis unit is also advantageously configured so as to calculate a discrepancy between the processing time and the execution period, and to generate a warning in the display if said discrepancy exceeds a configurable value.

Further automation components that communicate with the industrial controller are usually attached to the industrial controller, such as input/output assemblies. As a result, the recording device is advantageously configured so as to calculate a communication time comprising the time periods in which the control program is occupied with communication tasks for communication with automation components that are attached to the industrial controller, and to send this communication time to the analysis unit via the communication connection.

In a further embodiment, the analysis unit is advantageously configured such that further duration-relevant parameters can be modified interactively for a program module, and forwarded to the industrial controller via the communication connection. The consequences of these changes can then be seen immediately in the display.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method and of the system is explained in greater detail in the drawing, in which:

FIG. 1 is a schematic block diagram of a system for analyzing temporal flow characteristics of a control program of an industrial controller;

FIG. 2 is a schematic block diagram of the display of duration statistics with time values that are calculated in accordance with the method of the invention;

FIG. 3 is a schematic block diagram of a percental time distribution of times calculated in accordance with the method of the invention;

FIG. 4 is a schematic block diagram of the progress of a duration distribution in percental data;

FIG. 5 is a graphical plot of a display that takes the communication load into consideration;

FIG. 6 is a schematic block diagram of the communication load with reference to the duration share of program modules;

FIG. 7 shows a display of an animated flow layer model, wherein duration-relevant parameters can be directly adjusted; and

FIG. 8 is a flow chart of the method in accordance with an embodiment of the invention.

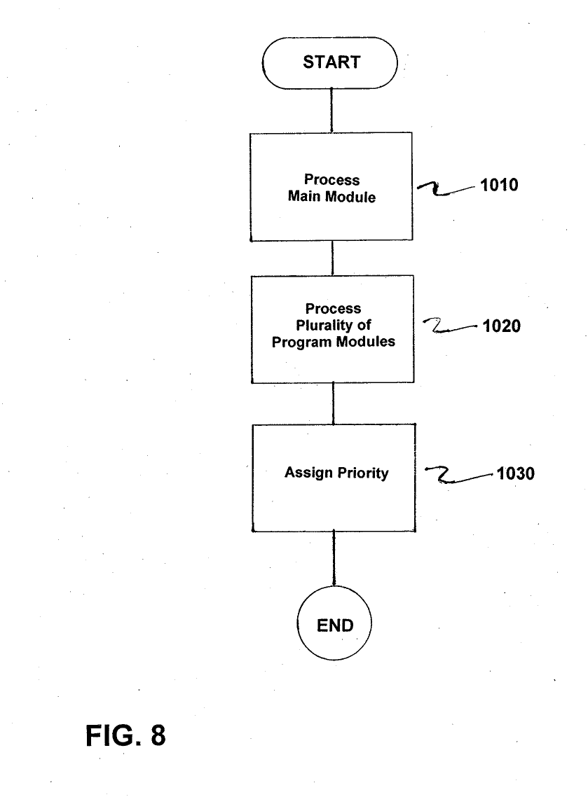

### DETAILED DESCRIPTION OF THE PRESENTLY PREFERRED EMBODIMENTS

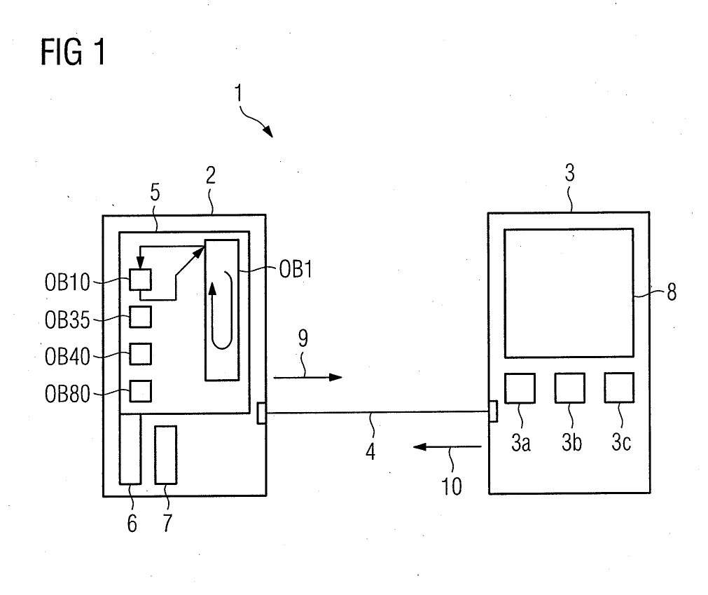

FIG. 1 illustrates a system 1 for analyzing temporal flow characteristics of a control program 5 of an industrial controller 2. The system 1 comprises the industrial controller 2 and an analysis unit 3, where the industrial controller 2 and the analysis unit 3 are linked together by a communication connection 4. The industrial controller 2 features the control program 5, which comprises a main module OB1 and a plurality of program modules OB10, OB35, OB40 and OB80.

OBs are known to the person skilled in the art as organization modules in stored programmable controls. For example, there is an OB1 for cyclical processing, an OB10 for a time alarm, an OB35 for a periodic wake-up alarm, an OB40 for a process alarm of input/output modules, where this signals specific states of an IO peripheral, an OB80 for a cycle time error in the event that an OB1 cycle exceeds a time period that has been set, an OB100 for an initialization in the event of an initialization of the stored programmable control (SPC), e.g., a transition from stop to run, an OB122 for an assembly error, etc.

An operating system 6 in the industrial controller 2 organizes the internal flows. The cyclical servicing of the main module OB1 is indicated by a circular arrow. Using the example of the program module OB10, the arrows indicate an interruption of the OB1 and subsequent return to the OB1.

The main module OB1 is processed cyclically following initialization of the industrial controller 2, and the processing of the program modules OB10, OB35, OB40 and OB80 is event-driven. In addition to their event-driven processing, the program modules OB10, OB35, OB40 and OB80 are serviced according to a priority model, each program module being assigned a processing priority for this purpose.

A recording device 7 is configured so as to calculate a processing time for each of the program modules OB10, OB35, OB40 and OB80, where the calculated processing time is derived from the difference between the time point at the end of processing and the time point at the start of processing of the respective program module OB10, OB35, OB40 and OB80. Furthermore, the recording device 7 is configured so as to allocate a module label of the respective program module OB10, OB35, OB40 and OB80 (i.e., “OB10”, “OB35”, “OB40” and “OB80”) to the processing time, and to forward the processing time to the analysis unit 3 via the communication connection 4. This forwarding occurs by a transmission 9, in which the processing time, an execution period and the module label are sent to the analysis unit 3.

The analysis unit 3 is configured so as to graphically represent the assignments of the processing time to the module label in a display 8. The analysis unit 3 has preparation device 3a for the graphical representation. Furthermore, the analysis unit 3 is configured so as to represent the processing priority of the program module (e.g., OB10) in the display 8 in addition to the module label (e.g., “OB10”) and the associated processing time, such that the processing priority can be modified interactively. Using a initiating device 3c for initiating changed parameters, the processing priority that has been changed in this way can be transferred to the program module concerned (e.g., OB10) via the communication connection 4 by a change command 10 to the control program 5, and immediately taken into consideration in the control program 5.

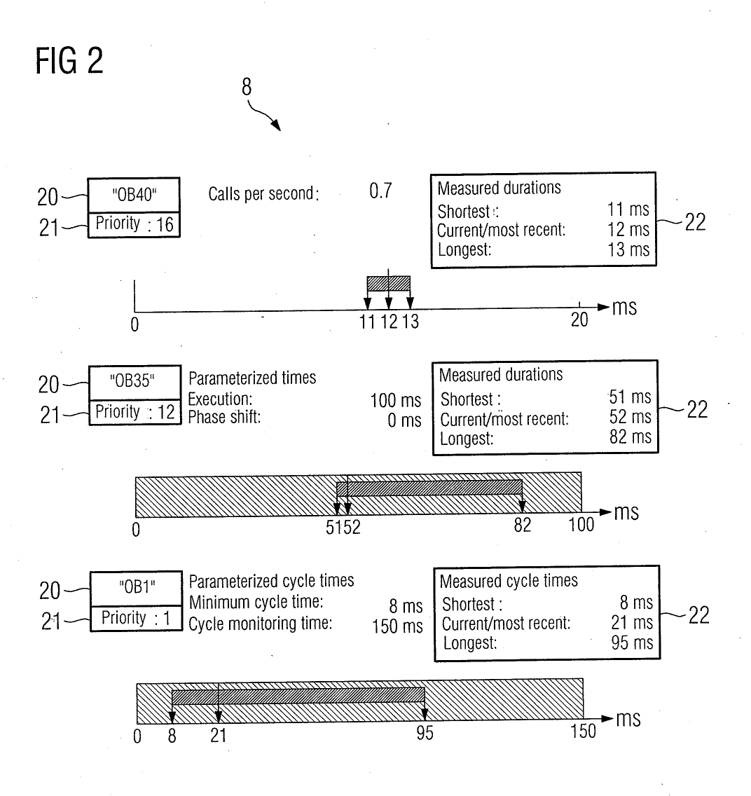

FIGS. 2 to 7 show different displays of module labels, priorities and associated measured durations, where a shortest, current and longest duration are also represented.

More specifically, FIG. 2 represents a display 8 for a duration distribution of the program modules OB40, OB35 and OB1. Here, a field for a module label 20 contains the text “OB40”. A further field for a processing priority 21 is arranged beneath this field. The display 8 is split into three parts. The top third represents the durations for the OB40, the central third represents the durations for the OB35, and the bottom third represents the durations for the OB1. The OB40 is a process alarm. As a result, no parameterized time is shown for this. However, a parameterized time is shown for the OB35 and the OB1. A parameterized execution time of 100 ms has been selected for the OB35. A parameterized cycle time of 150 ms has been selected for the OB40, corresponding to a maximal cycle monitoring time.

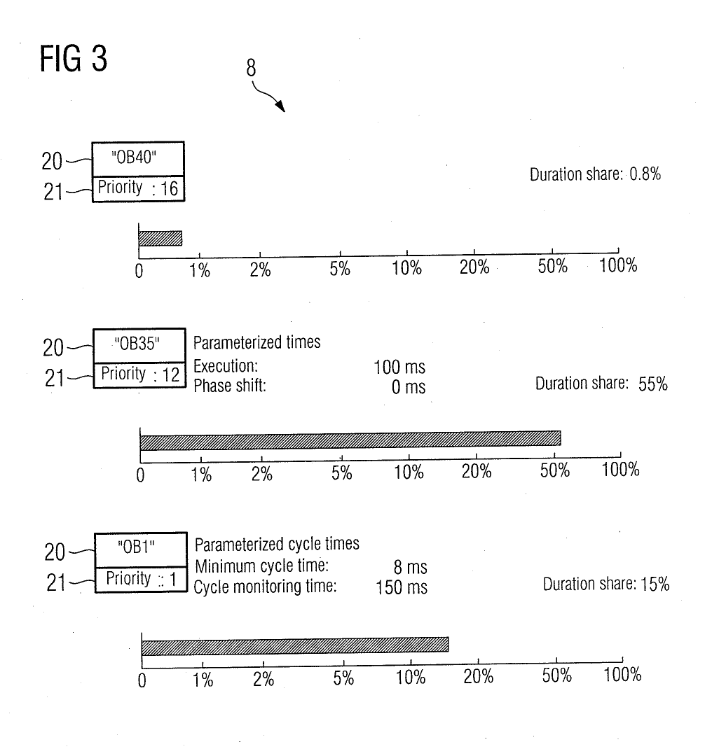

In a similar manner to the three-part representation of the display 8 in FIG. 2, a three-part representation has also been selected for the OB40, OB35 and OB1 according to FIG. 3. Here, however, the display 8 is configured such that a percental display of the duration shares of the respective program modules is provided for the user.

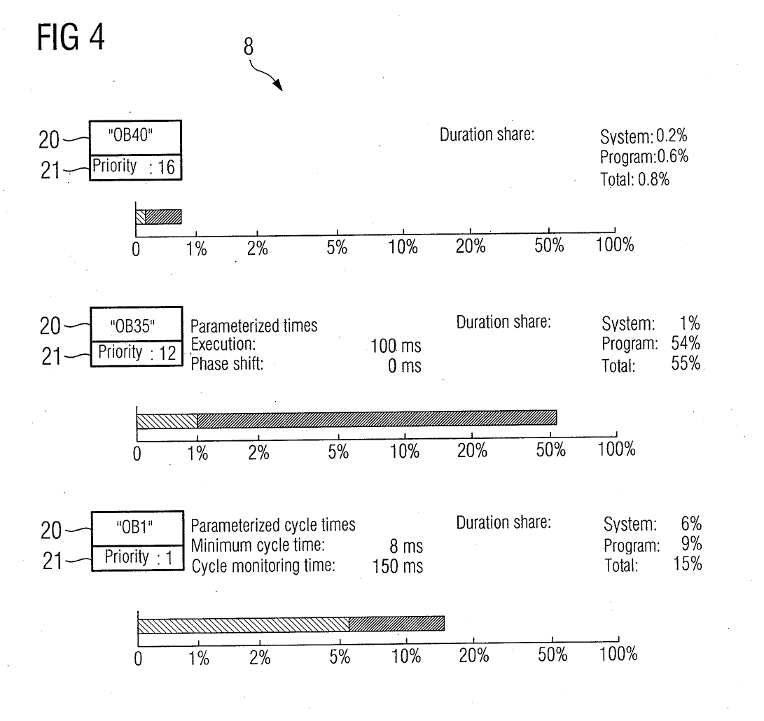

Supplementing the representation of the display 8 in FIG. 3, the display 8 in FIG. 4 shows the progress of a duration distribution, again as a percental representation. Here, the loading bars of the percental distribution are divided into two parts, where the average load and the currently prevailing load are both specified.

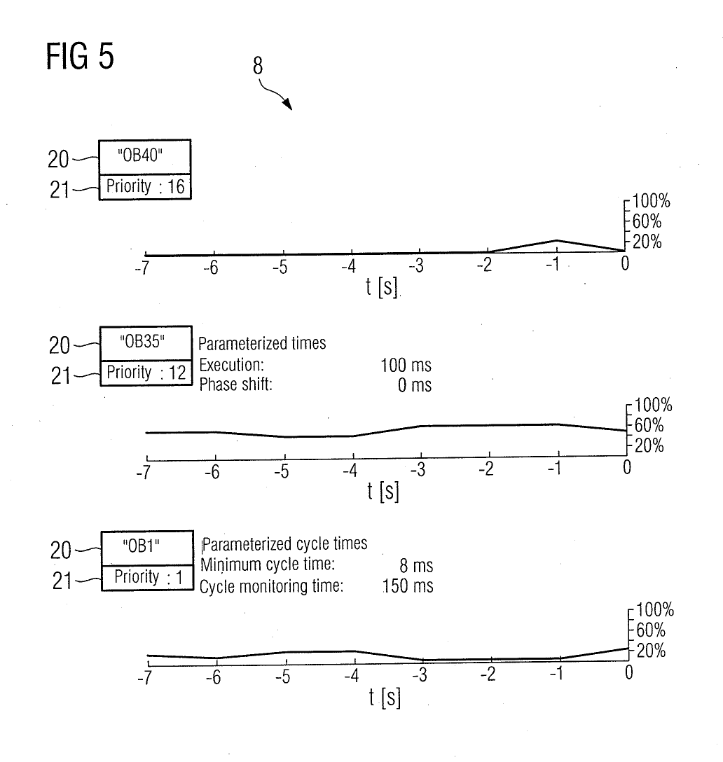

The graphical plot in the display depicted in FIG. 5 takes the communication load into consideration, where the communication load is composed of a communication time comprising the time periods in which the control program is occupied with communication tasks for communication with automation components that are attached to the industrial controller.

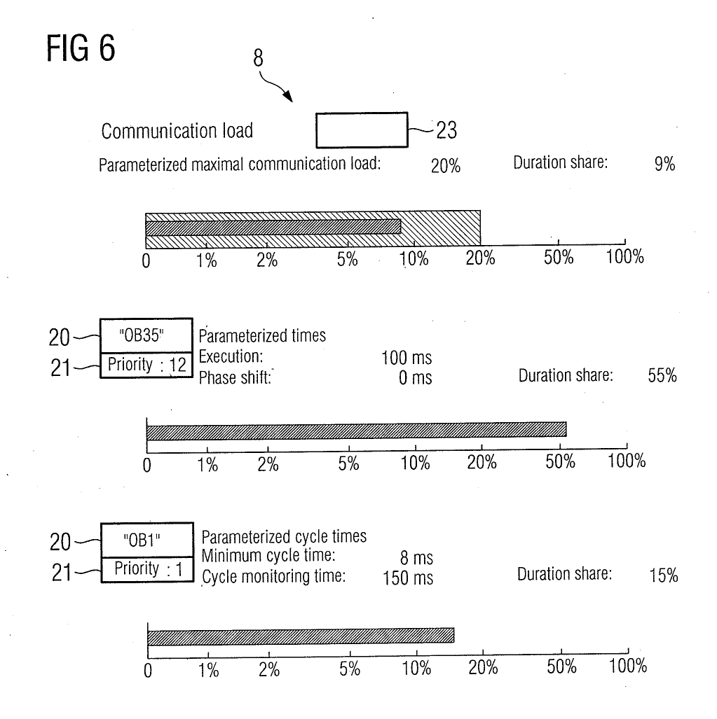

A further representation of the communication load is shown by the display 8 in FIG. 6. In addition to the percental indication of the communication load, the display 8 has a field 23 for indicating the communication time. A three-part representation was also selected for the display 8 in FIG. 6. A parameterized maximal communication load of 20% is shown in the top third. Within this maximal communication load of 20% is a bar extending to a communication load of 9%, which corresponds to the currently valid communication load. In the second third, a duration share of 55% is indicated for the OB35, which has a parameterized execution time of 100 ms. In the bottom third, a parameterized cycle monitoring time of 150 ms and a duration share of 15% are indicated for the OB1 in the display 8.

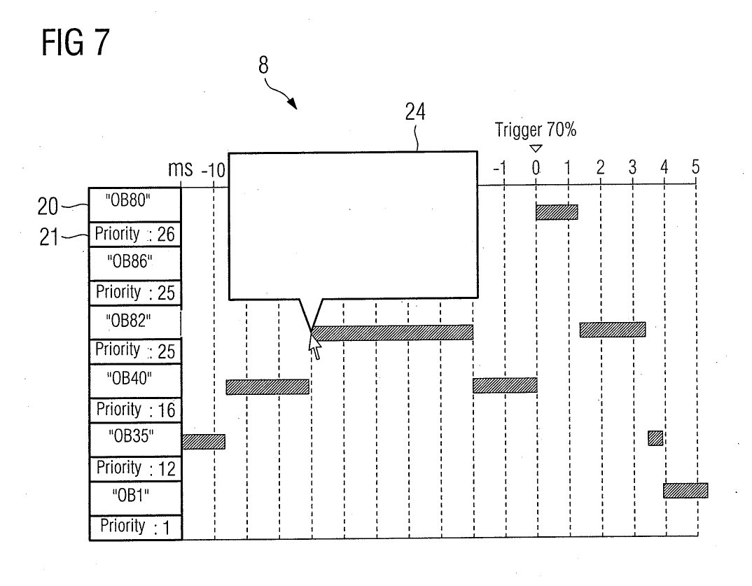

FIG. 7 represents an animated flow layer model in the display 8 for the program modules OB1, OB35, OB40, OB82, OB86 and OB80. The corresponding labels, such as “OB80”, are shown in the relevant fields for the module labels 20. A priority of 26 is shown in the field 21 for the processing priority of the OB80, for example. For each program module, a row exists in which a bar is represented as more or less long according to the processing time of the program module, e.g., OB80. In this representation and in the preparation of the measured times, a user can make changes, e.g., changes to the processing priority, in the user interface of the display 8. However, changes to duration-relevant parameters generally can also be made in this display 8. If changes are made in this flow layer model, the consequences of these changes are immediately visible.

A mouse pointer is shown in the row for the OB82. This mouse pointer is positioned over the bar for the execution time of the OB82. In this case, the analysis unit 3 from FIG. 1 is configured such that if a mouse pointer is positioned over an execution time bar, an information field 24 is opened in which further parameters relating to the program module concerned can be displayed and changed.

FIG. 10 is a flow chart of a method for analyzing temporal flow characteristics of a control program of an industrial controller, where the control program is divided into a main module and a plurality of program modules. The method comprises processing the main module cyclically following initialization of the industrial controller, as indicated in step 1010. The plurality of program modules are processed in an event driven manner, as indicated in step 1020. A respective processing priority is then assigned to each of the plurality of program modules, as indicated in step 1030.

For each of the plurality of program modules, the method further comprises calculating a processing time derived from a difference between a time point at an end of processing and a time point at a start of processing the respective program module of the plurality of programming modules, assigning a respective processing time to a module label of the respective program module of the plurality of programming modules, and graphically representing the assigned respective processing time in a display.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for analyzing temporal flow characteristics of a control program of an industrial controller, the control program being divided into a main module and a plurality of program modules, the method comprising:
processing the main module cyclically following initialization of the industrial controller;
processing the plurality of program modules in an event-driven manner; and
assigning a respective processing priority to each of the plurality of program modules;
wherein, for each of the plurality of program modules, the method further comprises:
calculating a processing time derived from a difference between a time point at an end of processing and a time point at a start of processing the respective program module of the plurality of programming modules;
assigning a respective processing time to a module label of the respective program module of the plurality of programming modules; and
graphically representing the assigned respective processing time in a display.

2. The method as claimed in claim 1, further comprising:
representing the respective processing priority of the respective program module in the display in addition to the module label and the processing time such that the respective processing priority is modifiable interactively and a changed processing priority is assigned to a relevant program module and is taken into consideration in the control program.

3. The method as claimed in claim 1, further comprising:
calculating an execution period of each program module of the plurality of program modules in addition to the respective processing time;
wherein the execution period is calculated from a sum of time periods in which the each program module of the plurality of program modules actively services its program instructions.

4. The method as claimed in claim 2, further comprising:
calculating an execution period of each program module of the plurality of program modules in addition to the respective processing time;
wherein the execution period is calculated from a sum of time periods in which the each program module of the plurality of program modules actively services its program instructions.

5. The method as claimed in claim 3, further comprising:
calculating a discrepancy between the processing time and the execution period; and
generating a warning in the display if the discrepancy exceeds a configurable value.

6. The method as claimed in one of claim 1, further comprising:
calculating a communication time comprising time periods in which the control program is occupied with communication tasks for communication with automation components attached to the industrial controller; and
displaying the calculated communication time in the display.

7. The method as claimed in claim 2, further comprising:
modifying interactively further duration-relevant parameters for the respective program module to optimize the temporal flow characteristics of the control program;
wherein the changed parameters concerned are immediately taken into consideration in the control program.

8. A system for analyzing temporal flow characteristics of a control program, comprising:
an industrial controller for processing the control program; and
an analysis unit connected to the industrial controller via a communication connection, the control program includes a main module and a plurality of program modules, the main module being processed cyclically following initialization of the industrial controller, processing of each of the plurality of program modules being event-driven, and a processing priority being assigned to each of the plurality of program modules;
a recording device arranged in the industrial controller, the recording device being configured to:
calculate a processing time for each program module of the plurality of program modules, the processing time being derived from a difference between a time point at an end of processing and a time point at a start of processing of a respective program module of the plurality of program modules; and
forward the processing time and a module label of the respective program module to the analysis unit via the communication connection; and
wherein the analysis unit is configured to graphically represent an assignment of the processing time to the module label of the respective module in a display.

9. The system as claimed in claim 8 wherein the analysis unit is configured to show the processing priority of the respective program module of the plurality of programming modules in the display in addition to the module label and the processing time, such that the processing priority is modifiable interactively, and to send a changed processing priority to the relevant program module via the communication connection in order that this processing priority can be taken into consideration in the control program.

10. The system as claimed in claim 8, wherein the recording device is additionally configured to calculate an execution period of the respective program module of the plurality of program modules, wherein the execution period is calculated from a sum of time periods in which the respective program module actively services its program instructions, and to forward said execution period to the analysis unit via the communication connection.

11. The system as claimed in claim 9, wherein the recording device is additionally configured to calculate an execution period of the respective program module of the plurality of program modules, wherein the execution period is calculated from a sum of time periods in which the respective program module actively services its program instructions, and to forward said execution period to the analysis unit via the communication connection.

12. The system as claimed in claim 10, wherein the analysis unit is configured to calculate a discrepancy between the processing time and the execution period, and to generate a warning in the display if the discrepancy exceeds a configurable value.

13. The system as claimed in claim 8, wherein the recording device is configured to calculate a communication time comprising time periods in which the control program is occupied with communication tasks for communication with automation components attached to the industrial controller, and to forward the communication time to the analysis unit via the communication connection.

14. The system as claimed in claim 8, wherein the analysis unit is configured to modify further duration-relevant parameters interactively for the respective program module of the plurality of program modules, and to forward the duration relevant parameters to the industrial controller via the communication connection.
